(19) United States
(12) Patent Application Publication
(10) Pub. No.: US 2023/0318442 A1
(43) Pub. Date: Oct. 5, 2023

(54) BATTERY SURGE REDUCTION BASED ON EARLY WARNING SIGNAL

(71) Applicant: TEXAS INSTRUMENTS INCORPORATED, Dallas, TX (US)

(72) Inventors: Kevin SCOONES, San Jose, CA (US); Sombuddha CHAKRABORTY, Redwood City, CA (US); Pourya ASSEM, Sunnyvale, CA (US); Reza SHARIFI, Sunnyvale, CA (US)

(21) Appl. No.: 17/708,982

(22) Filed: Mar. 30, 2022

(51) Int. Cl. H02M 1/32; H02M 1/00; H02M 1/084; H02M 3/158; H02J 7/00

(52) U.S. Cl. CPC H02M 1/32; H02M 1/0025; H02M 1/084; H02J 2207/20; H02J 7/00308; H02J 7/00304; H02M 3/1582

(57) ABSTRACT

A switching converter controller includes a synchronization circuit having a first synchronization circuit input, a second synchronization circuit input, a first synchronization circuit output, and a second synchronization circuit output. The synchronization circuit is configured to: receive an early warning signal at the first synchronization circuit input; receive a load detection signal at the second synchronization circuit input; provide a first control signal at the first synchronization circuit output responsive to the early warning signal; and provide a second control signal at the second synchronization circuit output responsive to the load detection signal. The switching converter controller also includes a driver circuit configured to adjust an idle switch drive signal at a first driver circuit output and a power switch drive signal at a second driver circuit output responsive to the first control signal and the second control signal.

### BACKGROUND

As new electronic devices are developed and integrated circuit (IC) technology advances, new IC products are commercialized. One example IC product is a switching converter, which provides an output voltage based on an input voltage. Switching converters include a controller and a power stage, and are used in various electronic devices to regulate power to one or more loads.

Battery surge due to sudden load demand is a common problem for electronic devices (e.g., smartphones) running off a single or dual battery. A conventional approach to mitigate the problem is to add costly multi-layer ceramic capacitors (MLCCs) at the power stage input and/or the power stage output to offset the current demand from the battery.

### SUMMARY

In one example embodiment, a switching converter controller comprises a synchronization circuit having a first synchronization circuit input, a second synchronization circuit, a first synchronization circuit output, and a second synchronization circuit output. The synchronization circuit is configured to: receive an early warning signal at the first synchronization circuit input; receive a load detection signal at the second synchronization circuit input; provide a first control signal at the first synchronization circuit output responsive to the early warning signal; and provide a second control signal at the second synchronization circuit output responsive to the load detection signal. The switching converter controller also comprises a driver circuit having a first driver circuit input, a second driver circuit input, a first driver circuit output and a second driver circuit output. The first driver circuit input is coupled to the first synchronization circuit output. The second driver circuit input is coupled to the second synchronization circuit output. The first driver circuit output is adapted to be coupled to a control terminal of an idle switch in parallel with an inductor of a power stage. The second driver circuit output is adapted to be coupled to a control terminal of a power switch of the power stage. The driver circuit is configured to adjust an idle switch drive signal at the first driver circuit output and a power switch drive signal at the second driver circuit output responsive to the first control signal and the second control signal.

In another example embodiment, a system comprises: a switching converter controller configured to selectively provide power switch drive signals and an idle switch drive signal responsive to an early warning signal and a load detection signal; power switches of a power stage coupled to the switching converter controller and controlled by the power switch drive signals; and an idle switch coupled to the switching converter controller and controlled by the idle switch drive signal, the idle switch in parallel with an inductor of the power stage.

### BRIEF DESCRIPTION OF THE DRAWINGS

FIG. 1 is a block diagram of a system in accordance with an example embodiment.

FIG. 2 is a block diagram of another system in accordance with an example embodiment.

FIGS. 3-7 are graphs of switching converter signals as a function of time in accordance with various example embodiments.

FIG. 8 is a flowchart of a switching converter method in accordance with an example embodiment.

### DETAILED DESCRIPTION

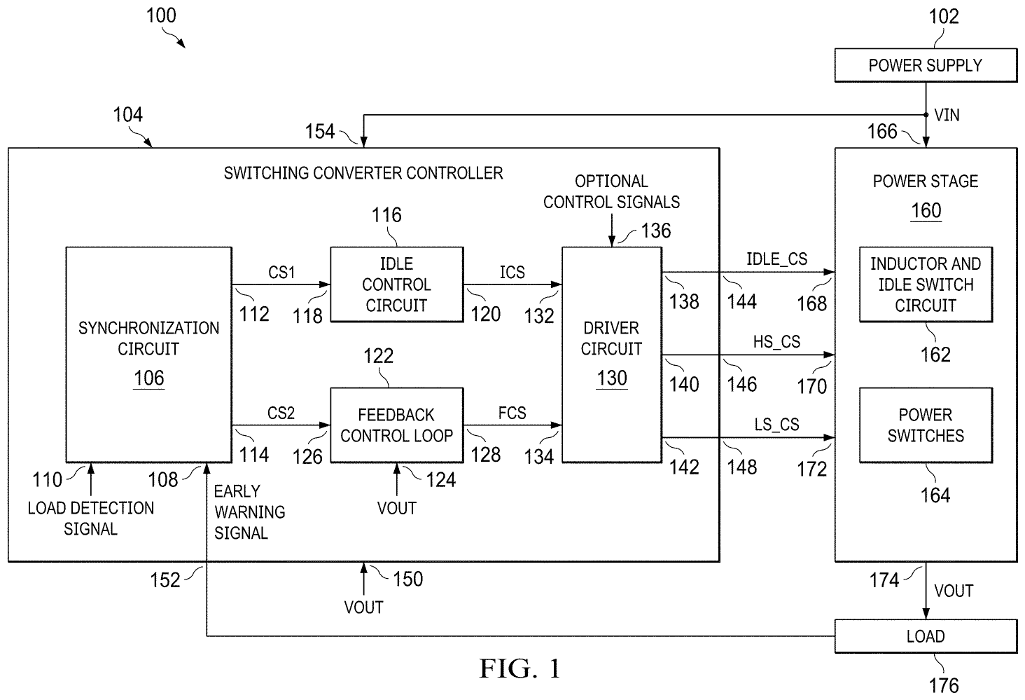

The same reference numbers (or other reference designators) are used in the drawings to designate the same or similar (structurally and/or functionally) features. FIG. 1 is a block diagram of a system 100 in accordance with an example embodiment. The system 100 represents any electrical device with a load 176, a power supply 102 (e.g., a battery or other direct-current (DC) power source), and power management circuitry including a power stage 160 and a switching converter controller 104. As shown, the power stage 160 includes: a power stage input 166; a first drive signal input 168; a second drive signal input 170; a third drive signal input 172; a power stage output 174; an inductor and idle switch circuit 162; and power switches 164. The power switches 164 have respective control terminals coupled to the second drive signal input 170 and the third drive signal input 172. The inductor and idle switch circuit 162 includes an inductor and idle switch in parallel. The control terminal of the idle switch is coupled to the first drive signal input 168.

In different example embodiments, the topology (e.g., the arrangement of the inductor and idle switch circuit 162 and the power switches 164) of the power stage 160 may vary. Example topologies for the power stage 160 include a boost converter topology, a buck converter topology, or a buck-boost converter topology. In a buck converter topology, VOUT at the power stage output 174 is less than the input voltage (VIN) provided to the power stage input 166 by the power supply 102. In a boost converter topology, VOUT is greater than VIN. In a buck-boost converter topology, VOUT may be greater than or less than VIN. In some example embodiments, the power stage 160 includes multiple inductor and idle switch circuits and multiple sets of power switches (e.g., a multi-phase power stage). In such embodiments, the switching converter controller 104 includes additional drive signals output for any additional power switches and idle switches. As another option, the idle switches for each inductor and idle switch circuit 162 may be included with the switching converter controller. In such embodiments, the switching converter controller 104 may omit outputs for idle switch drive signals since these drive signals will be internal to the switching converter controller 104. Instead, the switching converter controller 104 would include terminals to couple each power stage inductor in parallel with a respective idle switch included with the switching converter controller 104.

As shown, the switching converter controller 104 includes a first switching converter controller input 150, a second switching converter controller input 152, a third switching converter controller input 154, a first switching converter controller output 144, a second switching converter controller output 146, and a third switching converter controller output 148. The first switching converter controller input 150 is configured to receive VOUT from the power stage output 174. The second switching converter controller input 152 is configured to receive an early warning signal from the load 176. As another option, the system 100 includes a monitoring circuit or manager circuit separate from the load 176 to provide the early warning signal to the second input 152. The third switching converter controller input 154 is configured to receive VIN from the power supply 102. The first switching converter controller output 144 is configured to provide an idle switch drive signal (labeled “IDLE_CS”). The second switching converter controller output 146 is configured provide a high-side power switch drive signal (labeled “HS_CS”). The third switching converter controller output 148 is configured provide a low-side power switch drive signal (labeled “LS_CS”).

In some example embodiments, the switching converter controller 104 may include additional outputs for additional power switch drive signals and/or idle switch driver signals. to control power switches of the power stage 160. As another option, each idle switch may be part of the switching converter controller 104 or related IC. In such embodiments, the first switching converter controller output 144 is omitted and the switching converter controller 104 includes terminals to couple each idle switch in parallel with a respective inductor of the power stage 160.

To control the timing of the IDLE_CS, HS_CS, and LS_CS signals, the switching converter controller 104 includes a synchronization circuit 106 having a first synchronization circuit input 108, a second synchronization circuit input 110, a first synchronization circuit output 112, and a second synchronization circuit input 114. The first synchronization circuit input 108 is configured to receive the early warning signal. The second synchronization circuit input 110 is configured to receive a load detection signal. The load detection signal is, for example, VOUT or a signal based on VOUT dropping by a threshold amount.

In some example embodiments, the synchronization circuit 106 is configured to provide: a first control signal (CS1) at the first synchronization circuit output 112; and a second control signal (CS2) at the second synchronization circuit output 114. CS1 and CS2 are synchronized based on the early warning signal, the load detection signal, and possibly other criteria (e.g., the inductor current level, timers, or other criteria). In some example embodiments, the early warning signal is received approximately 20 to 50 us+decoding delay before a load increase. As shown, the switching converter controller 104 also includes an idle control circuit 116 having an idle control circuit input 118 and an idle control circuit output 120. In operation, the idle control circuit 116 is configured to provide an idle control signal (ICS) at the idle control circuit output 120 responsive to CS1 and possibly other criteria (e.g., the inductor current level, timers, and/or other criteria).

As shown, the switching converter controller 104 also includes a feedback control loop 122 having a first feedback control loop input 124, a second feedback control loop input 126, and a feedback control loop output 128. The first feedback control loop input 124 is configured to receive VOUT or a scaled version of VOUT. The second feedback control loop input 126 is configured to receive CS2. In operation, the feedback control loop 122 is configured to provide a feedback control signal (FCS) responsive to VOUT, a reference voltage (VREF), CS2, and/or other criteria. In some example embodiments, a feedforward signal may be used to adjust operations of the feedback control loop 122, where the feedforward signal is a function of VIN and/or VOUT and accounts for fast transients.

The switching converter controller 104 also includes a driver circuit 130. The driver circuit 130 includes a first driver circuit input 132, a second driver circuit input 134, third driver circuit inputs 136, a first driver circuit output 138, a second driver circuit output 140, and a third driver circuit output 142. The first driver circuit input 132 is configured to receive the idle control signal. The second driver circuit input 134 is configured to receive the feedback control signal from the feedback control loop output 128. The third driver circuit inputs 136 may to receive control signals based on control pulse frequency modulation (PFM) control, pulse-width modulation (PWM) control, multi-phase control, zero crossing detection, and/or other control options. In operation, the driver circuit 130 is configured to selectively provide: IDLE_CS to the first driver circuit output 138; HS_CS to the second driver circuit output 140; and LS_CS to the third driver circuit output 142 responsive to the idle control signal, the feedback control signal, and/or other criteria. As shown, the first driver circuit output 138 is coupled to the first switching converter controller output 144. The second driver circuit output 140 is coupled to the second switching converter controller output 146. The third driver circuit output 142 is coupled to the third switching converter controller output 148.

In some example embodiments, the first driver circuit output 138 (via the first switching converter controller output 144) is adapted to be coupled to a control terminal of an idle switch (e.g., the inductor of the indicator and idle switch circuit 162) in parallel with an inductor of the power stage 160. The second driver circuit output 140 (via the second switching converter controller output 146) is adapted to be coupled to the control terminal of one of the power switches 164 of the power stage 160. The third driver circuit output 142 (via the third switching converter controller output 148) is adapted to be coupled to the control terminal of another of the power switches 164 of the power stage 160. In operation, the driver circuit 130 is configured to adjust IDLE_CS, HS_CS, and LS_CS responsive to the first control signal (e.g., CS1 in FIG. 1), the second control signal (e.g., CS2 in FIG. 1), and/or other criteria.

In some example embodiments, the power stage 160 has multiple phases, each of the phases having a separate inductor. In such embodiments, the switching converter controller 104 is configured to selectively provide idle switch drive signals (e.g., IDLE_CS) for respective idle switches in parallel with each separate inductor responsive to the first control signal (e.g., CS1 in FIG. 1), the second control signal (e.g., CS2 in FIG. 1), and/or other criteria. In some example embodiments, the switching converter controller 104 is configured to provide power switch drive signals for the power switches 164 of the power stage 160 to increase inductor current in the inductor (e.g., the inductor of the inductor and idle switch circuit 162 in FIG. 1) responsive to the early warning signal and until the load detection signal is received.

In some example embodiments, the switching converter controller 104 is configured to provide the idle switch drive signal to the control terminal of an idle switch (e.g., the idle switch of the inductor and idle switch circuit 162 in FIG. 1) to maintain inductor current in the inductor responsive to the inductor current reaching a threshold and until the load detection signal is received. In some example embodiments, the switching converter controller is configured to provide the idle switch drive signal to the control terminal of the idle switch to maintain inductor current in the inductor responsive to the inductor current being increased for a time interval and until the load detection signal is received. In some example embodiments, the time interval is predetermined and fixed. In other example embodiments, the time interval is adjustable.

In some example embodiments, the early warning signal indicates that there will be an increased load without providing additional details. In other example embodiments, the early warning signal indicates what the increased load will be. As another option, the early warning signal may indicate the timing of the increased load. In embodiments where the early warning signal includes increased load details and/or timing information, the switching converter controller includes logic to recover the increased load details and/or timing information and adjust its operations (e.g., adjust the I_{L} target, adjust control/timing options for providing power switch drive signals, adjust control/timing options for providing idle switch drive signals, etc.).

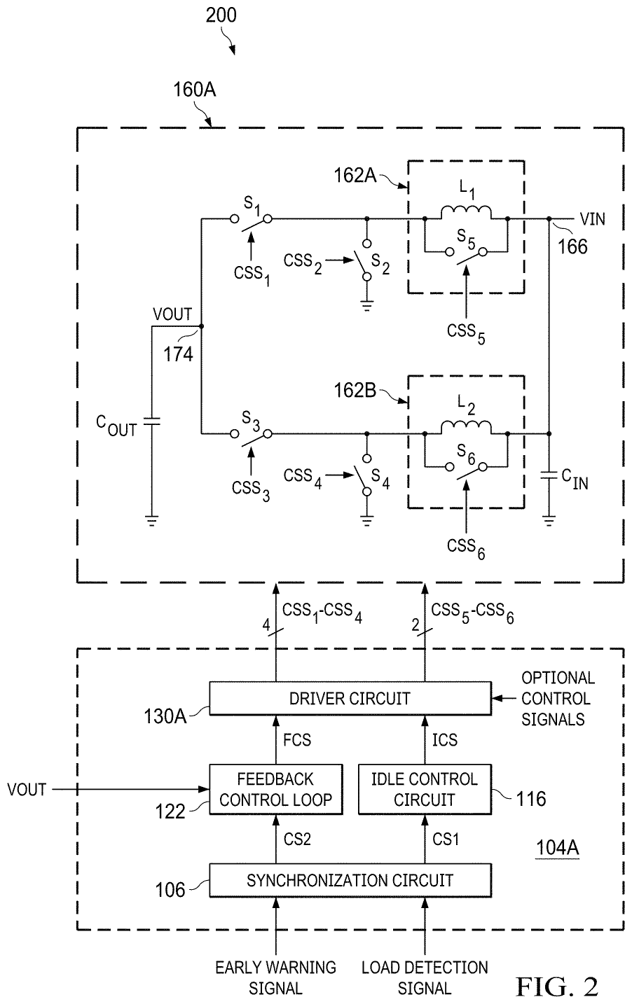

FIG. 2 is a block diagram of another system 200 in accordance with an example embodiment. As shown, the system 200 includes a switching converter controller 104A (an example of the switching converter controller 104 in FIG. 1). The switching converter controller 104A includes the synchronization circuit 106, the idle control circuit 116, and the feedback control loop 122 described in FIG. 1. Also, the switching converter controller 104A includes a driver circuit 130A (an example of the driver circuit 130 in FIG. 1). In the example of FIG. 2, the driver circuit 130A is configured to provide power switch drive signals (e.g., CSS₁-CSS₄) and idle switch drive signals (e.g., CSS₅ and CSS₆) responsive to the operations of the synchronization circuit 106, the idle control circuit 116, the feedback control loop 122, and related signals (e.g., the early warning signal, the load detection signal, CS1, CS2, ICS, FCS, VOUT, VREF, an inductor current level or related sense signals, timers, and/or other criteria). In some example embodiments, the driver circuit 130A is responsive to other control signals related to PFM control, PWM control, multi-phase control, zero crossing detection, and/or other control options.

In the example of FIG. 2, the power stage 160A (an example of the power stage 160 in FIG. 1) has a multi-phase boot converter topology. As shown, the power stage 160A includes an power stage input 166 configured to receive VIN (e.g., from a power supply such as the power supply 102 in FIG. 1). The power stage 160A also includes an input capacitor (C_{IN}) between the power stage input 166 and ground. A power stage output 174 of the power stage 160A is coupled to an output capacitor (C_{OUT}). More specifically, C_{OUT} is between the power stage output 174 and ground. The power stage output 174 is adapted to be coupled to a load (not shown). Between the power stage input 166 and the power stage output 174 are multiple phases, each phase having a respective inductor and idle switch circuit 162A and 162B. More specifically, the inductor and idle switch circuit 162A includes a first inductor (L₁) and an idle switch S₅ in parallel with L₁. The inductor and idle switch circuit 162B includes a second inductor (L₂) and an idle switch S₆ in parallel with L₂. In the example of FIG. 2, S₅ is controlled by CSS₅, and S₆ is controlled by CSS₆. In some example embodiments, idle switches, such as L₁ and L₂ have a bidirectional blocking topology.

In the example of FIG. 2, a first side of L₁ is coupled to the power stage input 166 and a second side of L₁ is coupled to the power stage output 174 via a first high-side power switch (S₁) controlled by CSS₁. The second side of L₁ is also coupled to ground via a first low-side power switch (S₂) controlled by CSS₂. As shown, a first side of L₂ is coupled to the power stage input 166, and a second side of L₂ is coupled to the power stage output 174 via a second high-side power switch (S₃) controlled by CSS₃. The second side of L₂ is also coupled to ground via a second low-side power switch (S₄) controlled by CSS₄. By selectively providing and synchronizing CSS₁-CSS₆ responsive to the early warning signal, the load detection signal, and/or other criteria, the switch converter controller 104A is able to reduce battery surge, which extends battery life and/or provide other benefits.

In different example embodiments, the number of phases for the power stage 160A may vary. Also, any idle switches (e.g., S₅ and S₆) could be included with the switching converter controller 104A. In such embodiments, CSS₅ and CSS₆ will be internal to the switching converter controller 104A. In such case, the switching converter controller 104A would include terminals to couple each idle switch in parallel with a respective inductor of the power stage 160A.

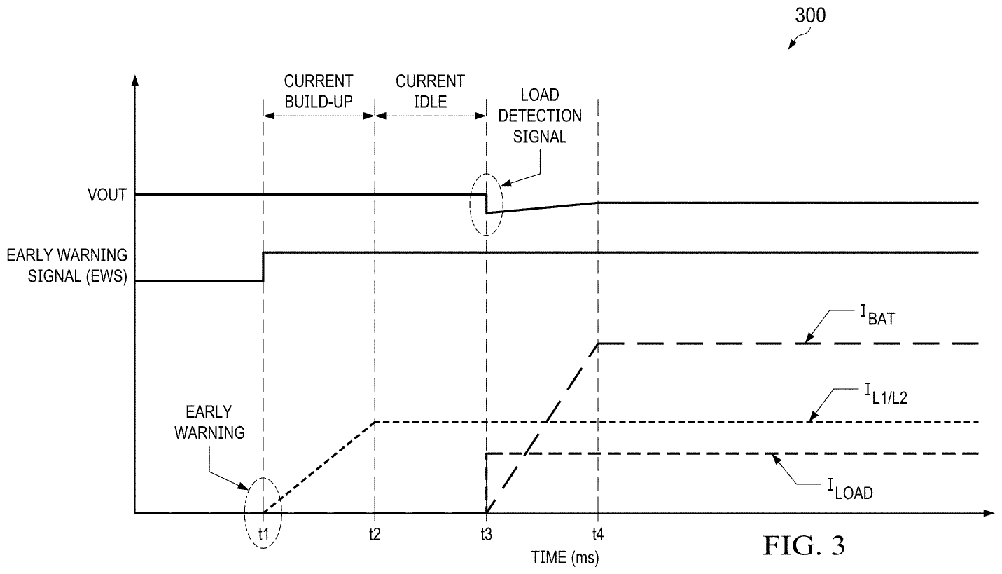

FIGS. 3-7 are graphs of switching converter signals as a function of time in accordance with various example embodiments. In graph 300 of FIG. 3, VOUT, an early warning signal (EWS), an inductor current of L₁ and L₂ (I_{L1/L2}), a load current (I_{LOAD}), and a battery current (I_{BAT}) are represented as a function of time. At time t1 in graph 300, EWS is asserted. In response, I_{L1/L2} increases (e.g., S₁ and S₃ off, S₂ and S₄ on, and S₅ and S₆ off in FIG. 2). At time t2, I_{L1/L2} has reached a threshold, or otherwise completed build-up, and I_{L1/L2} is maintained in an idle state by turning on the idle switches (e.g., S₁ to S₄ off, and S₅ and S₆ on in FIG. 2). The idle state is maintained until the load detection signal indicates a load increase at time t3. In some example embodiments, the load detection signal is based on VOUT dropping by at least a threshold amount. In response to the load detection signal at time t3, a load current is provided while maintaining I_{L1/L2}. For example, load current may be provided while maintaining an average I_{L1/L2} by alternating between a high-side active state (S₁ and S₃ on, S₂ and S₄ off, S₅ and S₆ off in FIG. 2) and a low-side active state (S₁ and S₃ off, S₂ and S₄ on, and S₅ and S₆ off in FIG. 2) at a given switching frequency. By using the early warning signal to trigger inductor current build-up and an idle state (to maintain I_{L} at a target level) before the load increases (as indicated by a drop in VOUT and/or assertion of the load detection signal), the amount of surge in I_{BAT} (i.e., the slope or overshoot of I_{BAT}) responsive to the load increase is reduced. In different example embodiments, it may be possible to adjust the duration of the inductor current build-up state and/or the idle state. With strategic timing of EWS and/or strategic inductor current build-up, the duration of the idle state can be reduced or possibly eliminated, which would improve efficiency.

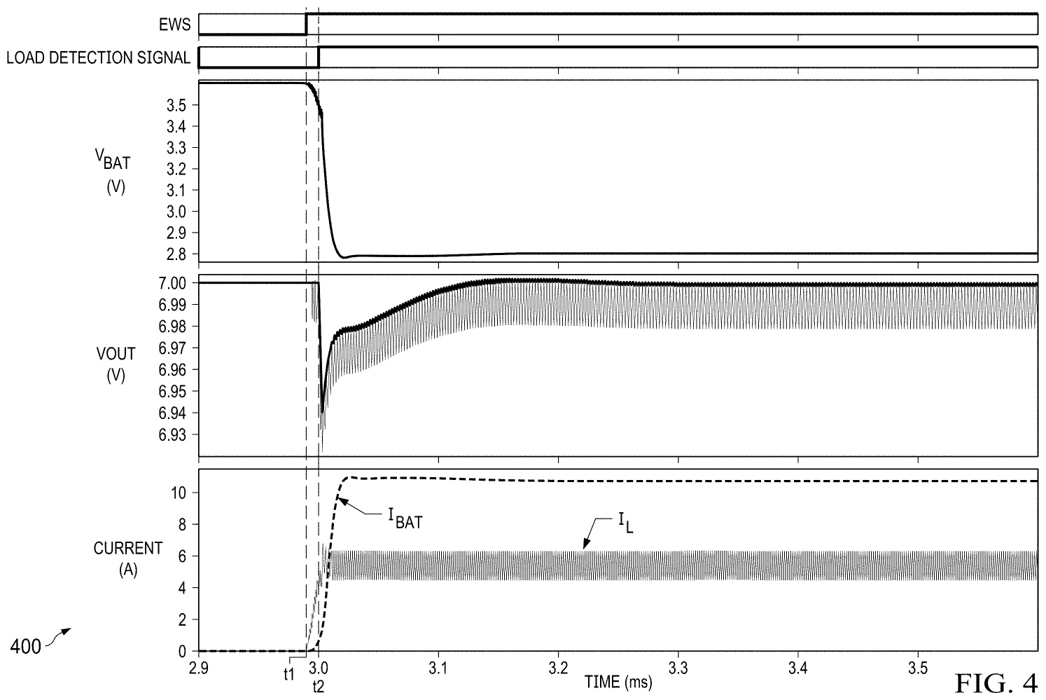

In graph 400 of FIG. 4, EWS, a load detection signal, V_{BAT}, VOUT, I_{BAT}, and I_{L} are represented as a function of time. At time t1 in graph 400, EWS is asserted. In response I_{L} is increased. At time t2, VOUT is reduced due to an increased load and the load detection signal is asserted. In response, I_{BAT} increases before eventually settling, V_{BAT} decreases before eventually settling, I_{L} is maintained within a range of I_{L} values, and VOUT increases and eventually settles to a range of VOUT values. By using the early warning signal to trigger inductor current build-up before the load increases (as indicated by a drop in VOUT and/or assertion of the load detection signal), the amount of surge in I_{BAT} (i.e., the slope or overshoot of I_{BAT}) responsive to the load increase is reduced.

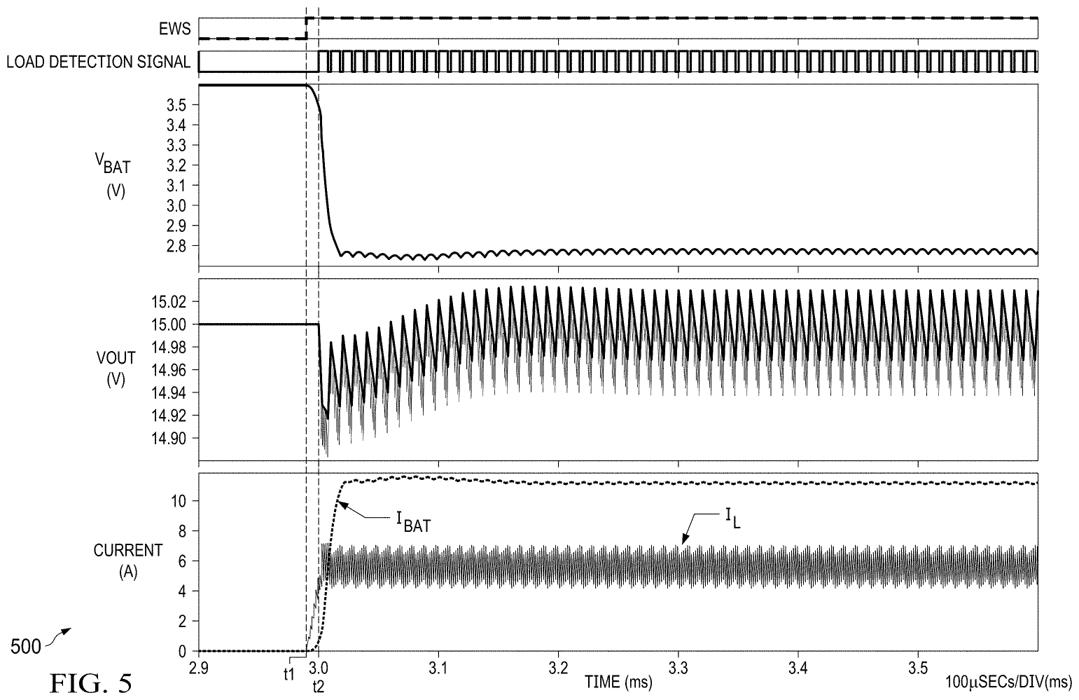

In graph 500 of FIG. 5, EWS, a load detection signal, V_{BAT}, VOUT, I_{BAT}, and I_{L} are represented as a function of time. At time t1 in graph 500, EWS is asserted. In response, I_{L} is increased. At time t2, VOUT is reduced due to an increased load and the load detection signal is asserted. In response, I_{BAT} increases, V_{BAT} decreases, I_{L} increases, and VOUT increases. As shown in graph 500, the load is periodic after time t2 (e.g., the load has a duty cycle after time t2). In response to the periodic load after time t2, I_{BAT} increases before eventually settling with some ripple to an average I_{BAT} value, V_{BAT} decreases before eventually settling with some ripple to an average V_{BAT} value, I_{L} is maintained within a range of I_{L} values, and VOUT is maintained within a range of values. By using the early warning signal to trigger inductor current build-up before the load increases (as indicated by a drop in VOUT and/or assertion of the load detection signal), the amount of surge in I_{BAT} (i.e., the slope or overshoot of I_{BAT}) responsive to the load increase is reduced.

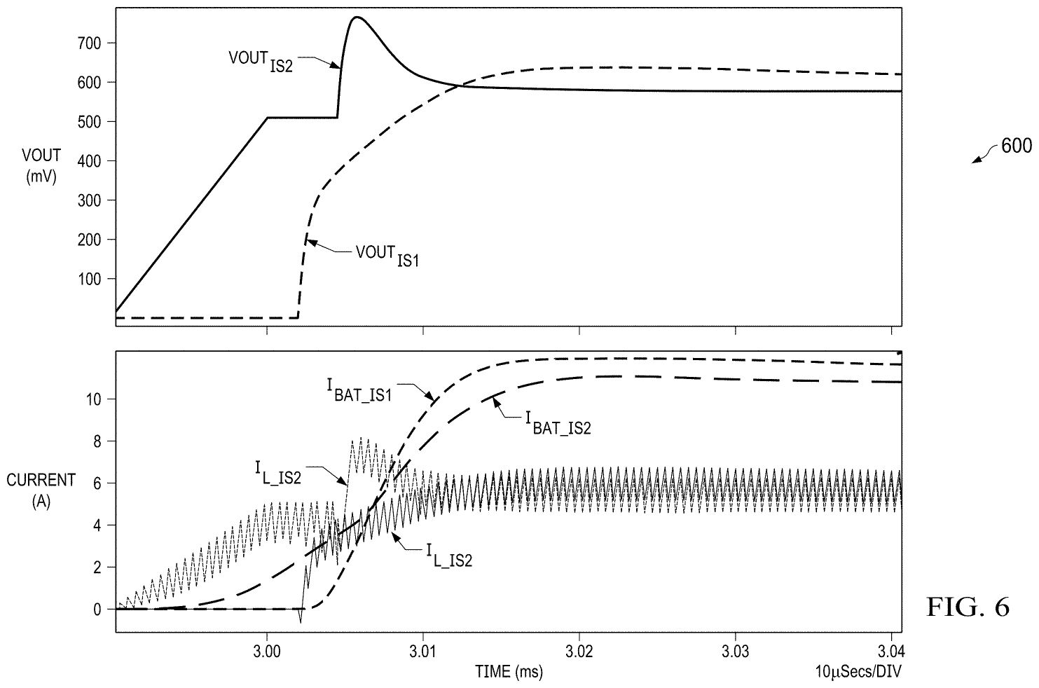

In graph 600 of FIG. 6, a first VOUT signal (VOUT_{IS1}), a second VOUT signal (VOUT_{IS1}), a first I_{BAT} signal (I_{BAT_IS1}), a second I_{BAT} signal (I_{BAT_IS2}), a first I_{L} signal (I_{L_IS1}), and a second I_{L} signal (I_{L_IS2}) are represented as a function of time. The different signals in graph 600 show the effect of different idle switch sizes on VOUT, I_{BAT}, and I_{L}. More specifically, VOUT_{IS1}, I_{BAT_IS1}, and I_{L_IS1} relate to a first idle switch (IS1) that is smaller than a second idle switch (IS2) related to VOUT_{IS2}, I_{BAT_IS2}, and I_{L_IS2}. As shown, VOUT_{IS1} and I_{BAT_IS1} settle to a higher value compared to VOUT_{IS2} and I_{BAT_IS2}. VOUT_{IS2} and I_{L_IS2} also experience more overshoot compared to VOUT_{IS1} and I_{L_IS1}. Also, the slope of I_{BAT_IS2} is less steep than then slope of I_{BAT_IS1}. In different example embodiments, the size of the idle switches is selected based on efficiency considerations (IS1 is more efficient and less costly than IS2), battery surge considerations (IS2 will decrease battery surge more than IS1), and/or other criteria.

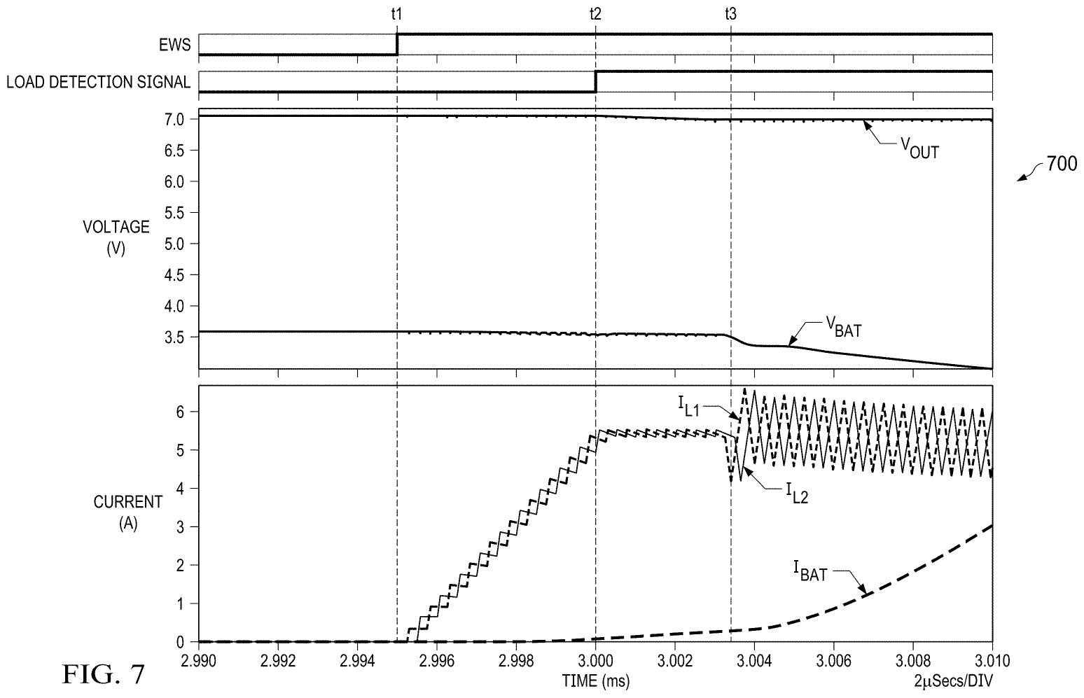

In graph 700 of FIG. 7, EWS, a load detection signal, VOUT, V_{BAT}, I_{L1}, I_{L2}, I_{BAT} are represented as a function of time. At time t1 in graph 700, EWS is asserted. In response I_{L1} and I_{L2} are increased. At time t2, the load detection signal is asserted. In response, and I_{L2} are maintained near a target value, VOUT and V_{BAT} are reduced slightly due to an increased load, and I_{BAT} increases slowly. At time t3, the load increases. In response, and I_{L2} increase and decrease within a target range, V_{BAT} is reduced, and I_{BAT} increases. By using the early warning signal to trigger inductor current build-up before the load increases, the amount of surge in I_{BAT} (i.e., the slope or overshoot of I_{BAT}) responsive to the load increase is reduced.

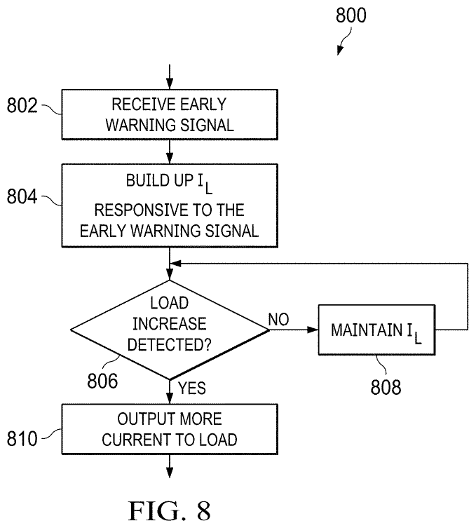

FIG. 8 is a flowchart of a switching converter method 800 in accordance with an example embodiment. The method 800 is performed, for example, by a switching converter controller (e.g., the switching converter controller 104 in FIG. 1, or the switching converter controller 104A in FIG. 2) and a power stage (e.g., the power stage 160 in FIG. 1, or the power stage 160A in FIG. 2). As shown, the method 800 includes receiving (e.g., by a switching converter controller) an early warning signal at block 802. At block 804, I_{L} is built-up responsive to the early warning signal. If a load increase is detected (determination block 806), more current is output to the load at block 810. If a load increase is not detected (determination block 806), I_{L} is maintained at block 808 and the method 800 returns to determination block 806. As needed, the method 800 may return to block 804 to increase I_{L} again if the load increase does not happen within a threshold time interval. With the method 800, power switch drive signals and idle switch drive signals are provided and synchronized as desired to build-up I_{L} in response to an early warning signal. As needed, a target I_{L} level is maintained before a load increase related to the early warning signal occurs. As described herein, the load increase may trigger a load detection signal that is used to trigger turning off an idle switch in parallel with a power stage inductor and then releasing current to the load.

In some example embodiments, a switching converter controller (e.g., the switching converter controller 104 in FIG. 1, or the switching converter controller 104A in FIG. 2) is configured to provide and synchronize power switch drive signals and an idle switch drive signal responsive to an early warning signal, a load detection signal, I_{L} reaching a threshold, timers, and/or other criteria. The power switch drive signals control the state of power switches of a power stage. The idle switch drive signal controls the state of an idle switch in parallel with an inductor of a power stage (e.g., an inductor of the inductor and idle switch circuit 162 in FIG. 1, or L₁ and L₂ in FIG. 2).

In some example embodiments, a system (e.g., the system 100 in FIG. 1, or the system 200 in FIG. 2) includes a switching converter controller (e.g., the switching converter controller 104 in FIG. 1, or the switching converter controller 104A in FIG. 2) configured to selectively provide power switch drive signals (e.g., HS_CS, LS_CS in FIG. 1, CSS₁ to CSS₄ in FIG. 2) and an idle switch drive signal (e.g., IDLE_CS in FIG. 1, or CSS₅ and CSS₆ in FIG. 2) responsive to an early warning signal and a load detection signal. Other criteria (e.g., the I_{L} level relative to a threshold, timers, or other criteria) may be used as well to determine the timing of power switch drive signals and idle switch drive signals. The system also includes power switches (e.g., the power switches 164 in FIG. 1, or S₁ to S₄ in FIG. 2) of a power stage (e.g., the power stage 160 in FIG. 1, or the power stage 160A in FIG. 2) coupled to the switching converter controller and controlled by the power switch drive signals. The system also includes an idle switch (e.g., the idle switch of the inductor and idle switch circuit 162 in FIG. 1, or S₅ and S₆ in FIG. 2) coupled to the switching converter controller and controlled by the idle switch drive signal. The idle switch is in parallel with an inductor (e.g., the inductor of the inductor and idle switch circuit 162 in FIG. 1, or L₁ or L₂ in FIG. 2) of the power stage.

In some example embodiments, the power stage has multiple phases, each of the phases having a separate inductor, and the switching converter controller is configured to selectively provide idle switch drive signals for respective idle switches in parallel with each separate inductor. In some example embodiments, the power stage has a multi-phase boost converter topology. In some example embodiments, the switching converter controller is configured to provide the idle switch drive signal to a control terminal of the idle switch to maintain inductor current in the inductor responsive to the inductor current reaching a threshold and until a load detection signal is received. In some example embodiments, the switching converter controller is configured to provide the idle switch drive signal to a control terminal of the idle switch to maintain inductor current in the inductor responsive to the inductor current being increased for a time interval and until a load detection signal is received. In some example embodiments, the time interval is predetermined and fixed. In other example embodiments, the time interval is adjustable.

In some example embodiments, the power stage has a buck converter topology and the switching converter controller is configured to maintain a target average inductor current in the inductor over time responsive to the early warning signal and until a load detection signal is received. In some example embodiments, the switching converter controller includes a synchronization circuit (e.g., the synchronization circuit 106 in FIGS. 1 and 2) configured to: receive a load detection signal; and synchronize operations of the power switches and the idle switch responsive to the early warning signal and the load detection signal. In some example embodiments, the system includes a battery (e.g., the power supply 102 in FIG. 1) coupled to the power stage, wherein the switching converter controller is configured to synchronize operations of the power switches and the idle switch responsive to the early warning signal and a load detection signal to reduce battery surge. In some example embodiments, the system includes a load (e.g., the load 176 in FIG. 1) configured to provide the early warning signal to the switching converter controller.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “electrode,” “node,” “interconnection,” “pin,” “contact,” and “connection” are used interchangeably. Unless specifically stated to the contrary, these terms are generally used to mean an interconnection between or a terminus of a device element, a circuit element, an integrated circuit, a device or other electronics or semiconductor component.

The example embodiments above may utilize switches in the form of n-channel field-effect transistors (“NFETs”) or p-channel field-effect transistors (“PFETs”). Other example embodiments may utilize NPN bipolar junction transistors (BJTs), PNP BJTs, or any other type of transistor for the switches described herein.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in this description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A switching converter controller comprising:
a synchronization circuit having a first synchronization circuit input, a second synchronization circuit, a first synchronization circuit output and a second synchronization circuit output, the synchronization circuit configured to:
receive an early warning signal at the first synchronization circuit input;
receive a load detection signal at the second synchronization circuit input;
provide a first control signal at the first synchronization circuit output responsive to the early warning signal; and
provide a second control signal at the second synchronization circuit output responsive to the load detection signal; and
a driver circuit having a first driver circuit input, a second driver circuit input, a first driver circuit output and a second driver circuit output, the first driver circuit input coupled to the first synchronization circuit output, the second driver circuit input coupled to the second synchronization circuit output, the first driver circuit output adapted to be coupled to a control terminal of an idle switch in parallel with an inductor of a power stage, the second driver circuit output adapted to be coupled to a control terminal of a power switch of the power stage, and the driver circuit configured to adjust an idle switch drive signal at the first driver circuit output and a power switch drive signal at the second driver circuit output responsive to the first control signal and the second control signal.

2. The switching converter controller of claim 1, further comprising an idle control circuit having an idle control circuit input and an idle control circuit output, the idle control circuit input coupled to the first synchronization circuit output, the idle control circuit output coupled to the first driver circuit input, and the idle control circuit configured to provide an idle control signal at the idle control circuit output responsive to the first control signal.

3. The switching converter controller of claim 1, further comprising a feedback control loop having a first feedback control loop input, a second feedback control loop input and a feedback control loop output, the second feedback control loop input coupled to the second synchronization circuit output, the feedback control loop output coupled to the second driver circuit input, and the feedback control loop configured to:
receive an output voltage (VOUT) value related to the power stage at the first feedback control loop input; and
provide a feedback control signal at the feedback control loop output response to the VOUT value and a reference voltage (VREF).

4. The switching converter controller of claim 1, wherein the power stage has multiple phases, each of the phases having a separate inductor, and the switching converter controller is configured to selectively provide idle switch drive signals for respective idle switches in parallel with each separate inductor responsive to the first control signal and the second control signal.

5. The switching converter controller of claim 1, wherein the switching converter controller is configured to provide power switch drive signals for power switches of the power stage to increase inductor current in the inductor responsive to the early warning signal and until the load detection signal is received.

6. The switching converter controller of claim 5, wherein the switching converter controller is configured to provide the idle switch drive signal to the control terminal of the idle switch to maintain inductor current in the inductor responsive to the inductor current reaching a threshold and until the load detection signal is received.

7. The switching converter controller of claim 5, wherein the switching converter controller is configured to provide the idle switch drive signal to the control terminal of the idle switch to maintain inductor current in the inductor responsive to the inductor current being increased for a time interval and until the load detection signal is received.

8. The switching converter controller of claim 7, wherein the time interval is predetermined and fixed.

9. The switching converter controller of claim 7, wherein the time interval is adjustable.

10. A system comprising:
a switching converter controller configured to selectively provide power switch drive signals and an idle switch drive signal responsive to an early warning signal and a load detection signal;
power switches of a power stage coupled to the switching converter controller and controlled by the power switch drive signals; and
an idle switch coupled to the switching converter controller and controlled by the idle switch drive signal, the idle switch in parallel with an inductor of the power stage.

11. The system of claim 10, wherein the power stage has multiple phases, each of the phases having a separate inductor, and the switching converter controller is configured to selectively provide idle switch drive signals for respective idle switches in parallel with each separate inductor.

12. The system of claim 11, wherein the power stage has a multi-phase boost converter topology.

13. The system of claim 10, wherein the switching converter controller is configured to provide the idle switch drive signal to a control terminal of the idle switch to maintain inductor current in the inductor responsive to the inductor current reaching a threshold and until a load detection signal is received.

14. The system of claim 10, wherein the switching converter controller is configured to provide the idle switch drive signal to a control terminal of the idle switch to maintain inductor current in the inductor responsive to the inductor current being increased for a time interval and until a load detection signal is received.

15. The system of claim 14, wherein the time interval is predetermined and fixed.

16. The system of claim 14, wherein the time interval is adjustable.

17. The system of claim 10, wherein the power stage has a buck converter topology and the switching converter controller is configured to maintain a target average inductor current in the inductor over time responsive to the early warning signal and until a load detection signal is received.

18. The system of claim 10, wherein switching converter controller includes a synchronization circuit configured to:
receive a load detection signal; and
synchronize operations of the power switches and the idle switch responsive to the early warning signal and the load detection signal.

19. The system of claim 10, further comprising a battery coupled to the power stage, wherein the switching converter controller is configured to synchronize operations of the power switches and the idle switch responsive to the early warning signal and a load detection signal to reduce battery surge.

20. The system of claim 10, further comprising a load configured to provide the early warning signal to the switching converter controller.
